(19) United States
(12) Patent Application Publication
(10) Pub. No.: US 2009/0033969 A1
(43) Pub. Date: Feb. 5, 2009

(54) IMAGE CONTROL APPARATUS AND IMAGE CONTROL METHOD

(75) Inventor: Kenji Inoue, Hiratsuka-shi (JP)

Correspondence Address: COWAN LIEBOWITZ & LATMAN P.C.;JOHN J TORRENTE, 1133 AVE OF THE AMERICAS, NEW YORK, NY, 10036, US

(73) Assignee: Canon Kabushiki Kaisha, Tokyo (JP)

(21) Appl. No.: 12/280,830

(22) PCT Filed: Feb. 28, 2007
(86) PCT No.: PCT/JP2007/054367

§ 371 Date: Aug. 27, 2008

(30) Foreign Application Priority Data
Mar. 7, 2006 (JP) 2006-061226

(51) Int. Cl. H04N 1/60

(52) U.S. Cl. 358/1.9

(57) ABSTRACT

An image display system in which an image output equipment and an image control apparatus are connected by a moving image digital interface such as HDMI, executes a battery saving in the image output equipment in case of a still image display. The image display system discriminates whether an image, input by an externally-connected digital image output apparatus is a still image, and stores the input image in a frame memory. In case of a discrimination as a still image, the discrimination as a still image is informed to the digital image output apparatus, and the image read out from the frame memory is used for display on a connected display apparatus.

### TECHNICAL FIELD

The present invention relates to an image control apparatus for controlling display of an output of an image output apparatus utilizing a digital interface, and more specifically to an image control apparatus effecting power saving control in case of inputting a still image utilizing a moving image input terminal.

### BACKGROUND ART

A method of displaying an image by connecting an image output apparatus such as a digital camera and a computer by a digital interface, is already known. For example, Japanese Patent Application Laid-open No. H07-049680 discloses a digital image display system in which a transmission loss is reduced by transmitting an image signal as a digital drawing command signal. Also Japanese Patent Application Laid-open No. H09-163209 discloses a system for reducing power consumption by controlling a power supply of a digital camera, connected to a personal computer (hereinafter represented as PC), by the PC.

Recently, HDMI (High-Definition Multimedia Interface) is being adopted as a digital interface, in an image display system such as a television.

HDMI is an extension of DVI (Digital Visual Interface), employed widely in PC, to audio-visual equipment. It employs, as a data transmission system, TMDS (Transition Minimized Differential Signaling) same as in DVI. The HDMI is principally different from DVI in including a copyright protection mechanism HDCP (High-Bandwidth Digital Content Protection), also in adopting a smaller connector for better handling, and in an ability to transmit image and sound by a single cable.

On the other hand, in case of connecting an output of a digital image output apparatus, such as a digital camera or a digital video camera, to an image display system such as a television, (1) a method of utilizing a composite output utilizing an RCA analog connector or (2) a method of reading out from a memory card, has been utilized in many cases.

The case (1) involves an image quality deterioration, since the digital image is converted into an analog interlaced image, so that the luminance and the color difference are transmitted together.

Also in the case (2), the digital image can be used in its original format, but the memory card has to be extracted from the output apparatus and a data destruction may occur at such operation. In addition, a memory card slot has to be provided also on the image display system.

Also in PC, a file transfer method utilizing USB (Universal Serial Bus) is commonly utilized, but it is not so common in the television or the like, because the file management method becomes cumbersome. The television, even when equipped with an USB terminal, is generally used in a similar manner to the case (2), by connecting a memory card reader.

Because of such situation, it is desired, also in a digital image output apparatus such as a digital camera or a digital video camera, to provide such an apparatus with a terminal which is directly connectable with HDMI.

However, since HDMI handles the image as a moving image, the digital image output apparatus has to continue to transmit every frame image, in synchronization with the vertical synchronization signal. Therefore, even in case of outputting a still image from the digital image output apparatus, an image output state has to be maintained constantly while the image display is executed.

It therefore involves a drawback of a larger power consumption, in comparison with the memory card system described above.

Since a compact digital image output apparatus such as a digital camera is often driven with a battery, a larger power consumption is less desirable. For example, an excessive consumption of the battery while viewing images may result in a situation of a battery exhaustion in an image capturing operation, whereby the image capture cannot be executed.

### DISCLOSURE OF THE INVENTION

The present invention is to provide an image control apparatus capable of solving the aforementioned problems and capable of achieving a low power consumption control.

According to an aspect of the present invention, provided is an image control apparatus, with a display apparatus, capable of processing an image signal, input by an image output apparatus externally connected through a cable, so that an appropriate image display is executed on the display apparatus. In the case that the image signal output from the image output apparatus is an image signal for displaying a still image, the input image signal from the image output apparatus is not output to the display apparatus, but an image signal corresponding to the still image, stored in a frame memory of the image control apparatus, is output. More specifically, the image control apparatus of the present invention includes a discrimination unit for discriminating whether the input image signal is an image signal for displaying a still image or is an image signal for displaying a moving image, and a switching-over unit for selectively outputting the input image signal and the image signal read out from the frame memory, based on an output of the discrimination unit. Also the image control apparatus of the present invention also has a function of informing the image output apparatus, that the image signal stored in the frame memory is being output to the image output apparatus.

According to information from the image control apparatus, the image output apparatus is therefore capable of terminating the output of the image signal for a still image, and shifting to a power saving mode such as a battery saving mode or a sleep mode.

Also the present invention is applicable not only to HDMI, but also to an image transmission utilizing IEEE1394 or LAN, in case of handling a digital still image as a moving image.

The image control apparatus of the present invention provides a particularly significant technological effect in battery saving in a digital image output apparatus which is connected to the image control apparatus and which is driven by a battery.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a block diagram of an image display system of a first embodiment.

FIG. 2 is a block diagram of an image processing unit of the first embodiment.

FIG. 3 is a schematic view illustrating relations of signals in the first embodiment.

FIG. 4 is a flow chart for describing functions of an image output apparatus of the first embodiment.

FIG. 5 is a flow chart for describing functions of an image control apparatus of the first embodiment.

FIG. 6 is a block diagram of an image display system of a second embodiment.

FIG. 7 is a block diagram of an image processing part of the second embodiment.

FIG. 8 is a schematic view illustrating relations of signals in the second embodiment.

FIG. 9 is a flow chart for describing functions of an image output apparatus of the second embodiment.

FIG. 10 is a flow chart for describing functions of an image control apparatus of the second embodiment.

### BEST MODE FOR CARRYING OUT THE INVENTION

### Exemplary Embodiment 1

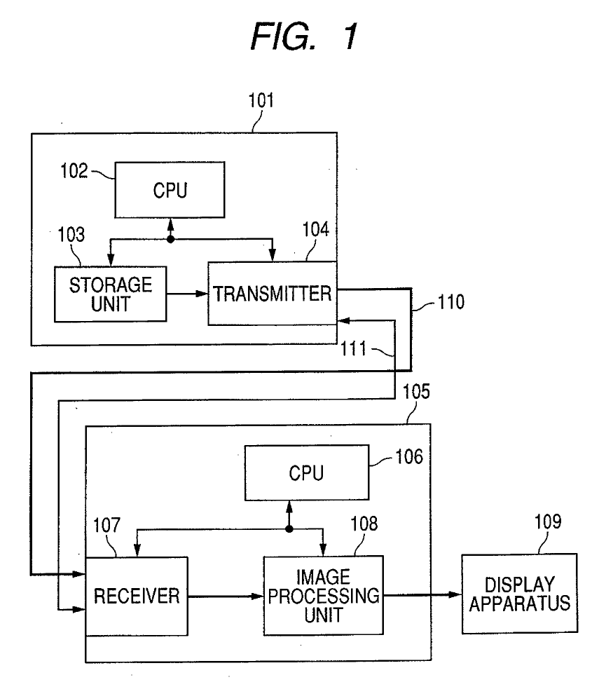

FIG. 1 is an entire block diagram illustrating an image display system utilizing an image control apparatus of the present invention.

The image display system includes an image output apparatus 101, an image control apparatus 105 and a display apparatus 109.

The image output apparatus 101 is advantageously a compact battery-driven visual equipment for outputting a digital image signal, such as a digital still camera (DSC) or a digital video camera (DVC). Also a digital interface to be used for signal transmission between the image output apparatus 101 and the image control apparatus 105 or signal transmission between the image control apparatus 105 and the display apparatus 109 is an interface for a moving image, such as HDMI.

The image output apparatus 101 outputs, according to an instruction of a CPU 102, an image stored in a storage unit 103, to the external through a transmitter 104. For example in case of HDMI, the transmitter 104 converts the image signal into a TMDS signal of differential transmission type and transmits it as a non-compressed image signal.

The digital image signal, output from the image output apparatus 101, is input through a signal line 110 for transmitting the image signal, into the image control apparatus 105.

In the image control apparatus 105, a receiver 107, constituting an input/output unit, receives the image signal. The receiver 107 converts the received image signal into a signal format that can be processed by a subsequent image processing unit 108, and then transmits the converted image signal to the image processing unit 108 following the receiver 107. The image processing unit 108 executes image processing described below, according to an instruction from the CPU 106, and transfers the image signal to the display apparatus 109. The display apparatus 109 displays an image, based on the input image signal.

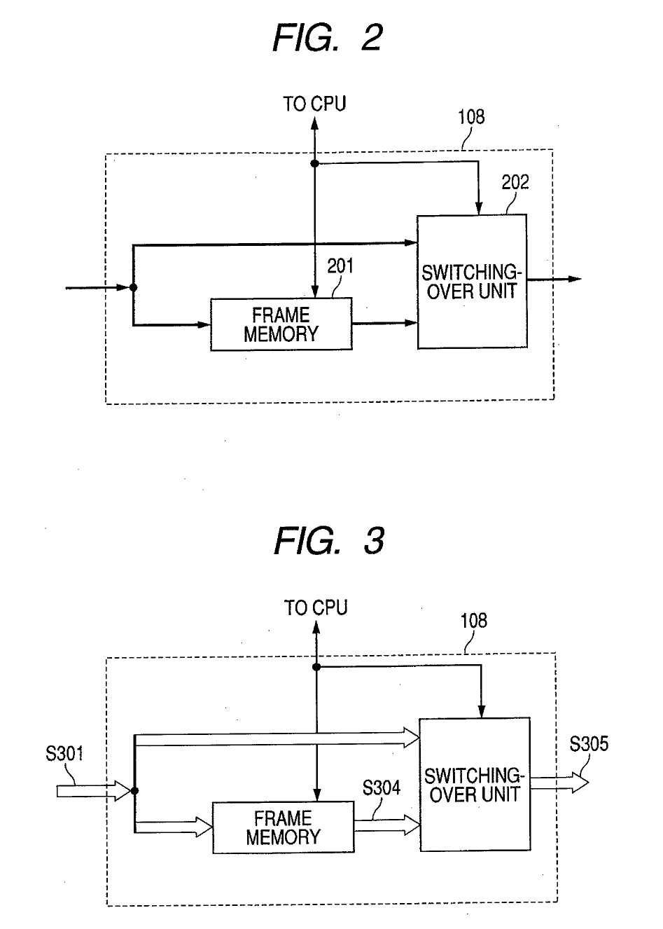

FIG. 2 illustrates details of the image processing unit 108. The image processing unit 108 executes various image processing such as a conversion of resolution and a regulation of luminance, but, for the purpose of simplicity, only image processing having close relation to the present invention will be described.

The image processing unit 108 includes a frame memory 201 capable of storing the image signal of at least a frame, and a switching-over unit 202 for outputting the image signal under switching-over.

In the case that the image signal input into the image control apparatus 105 is a moving image, the transmitter 104 of the image output apparatus 101, being an interface for outputting a moving image, handles it as an ordinary image output, and a signal line 111 for transmitting a control signal is not used.

FIG. 3 is a view illustrating a signal flow in the image processing unit 108, when a moving image data is entered into the image control apparatus 105.

In the case of a moving image input, the image processing unit 108 does not execute a processing but outputs the input image signal S301 as it is. The switching-over unit 202 selects the input image signal S301 among the input image signal S301 and an image signal S304 of a preceding frame read out from the frame memory 201, and outputs it as an output image signal S305.

In the present case, an operation of writing and reading the image signal into and from the frame memory 201 is also executed even in case of a moving image input, but the writing/reading operation may be terminated in case of the moving image, by an instruction from the CPU 106.

On the other hand, in the case that the image input into the image control apparatus 105 is a still image, the image output apparatus 101 informs, utilizing the signal line 111, the image control apparatus 105 of a fact that the output image is a still image. The receiver 107 transmits the information that the input image is a still image, to the CPU 106 serving as the discrimination unit. The CPU 106 controls the image control unit 108 according to such information.

In case of a still image input, the image processing unit 108 terminates the writing of image data into the frame memory 201, according to the instruction from the CPU 106. It is assumed that the frame memory 201 stores at least a frame of the still image. Then the CPU 106 gives an instruction to the switching-over unit 202, which selects the image signal S304 among the input image signal S301 and the image signal S304 preceding by at least a frame, read from the frame memory 201, and outputs it as the output image signal S305.

When the output switching-over operation of the switching-over unit 202 is completed, the CPU 106 controls the receiver 107 so as to output, through the signal line 111, an information signal as a control signal for controlling the output of the image signal from the image output apparatus. By the information signal, the image output apparatus 101 is informed that the image control apparatus 105 is in the course of outputting the image signal from the frame memory 201.

In the image output apparatus 101, such information is transmitted through the transmitter 104 to the CPU 102. The CPU 102, not being required to continue the output of the image signal, shifts to a power saving mode in which the output of the image signal is terminated, and enters a state waiting for a new input from the user.

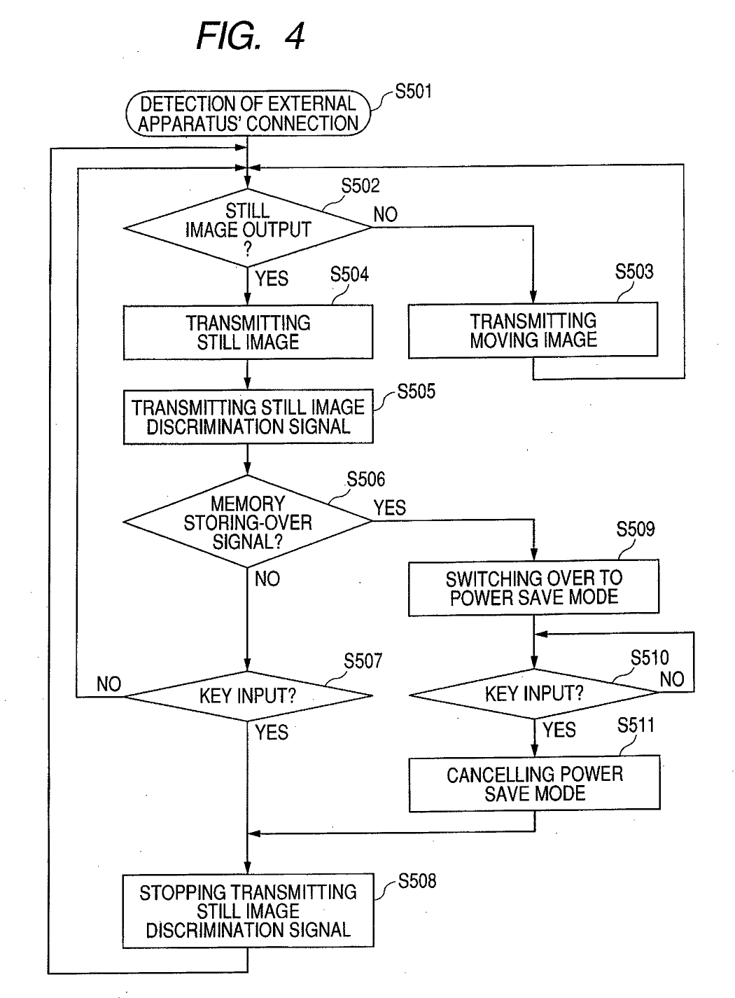

FIG. 4 is a flow chart describing the functions of the image output apparatus 101.

When a connection, through a cable, to the image control apparatus 105 of the present invention is detected (S501), a discrimination is made (S502) as to whether the output request from the user is for a still image or a moving image.

In the case that the request from the user is the output of a moving image, a moving image signal is transmitted from the digital interface (S503).

On the other hand, in the case that the request from the user is the output of a still image, a still image signal is transmitted from the digital interface (S504). In the case of a still image output, a still image discrimination signal is transmitted (S505) to inform the image control apparatus 105 that the transmitted signal is a still image. Upon receiving the still image discrimination signal, the image control apparatus 105 informs the image output apparatus 101 whether the still image signal is stored in the memory, by a memory storing-over signal. The image output apparatus 101 discriminates presence/absence of the memory storing-over signal (S506).

In the case of absence of the memory storing-over signal or in the case of connection to an equipment other than the image control apparatus 105 of the present invention, a state of waiting for a key input from the user is started (S507).

In the absence of the key input, the sequence proceeds to S502 whereby the output of the still image is executed in continuation.

When a key input is present in S507, the transmission of the still image discrimination signal is terminated (S508) and an instruction by the key input from the user is executed, whereupon the sequence proceeds to S502.

On the other hand, when the memory storage-over signal is present in S506, the image output apparatus 101 shifts to a power saving mode (S509) and terminates the output of the image signal.

Thereafter, a state of waiting for a key input from the user is started (S510).

When a key input from the user is detected in S510, the power saving mode is canceled (S511) and the sequence proceeds to S508.

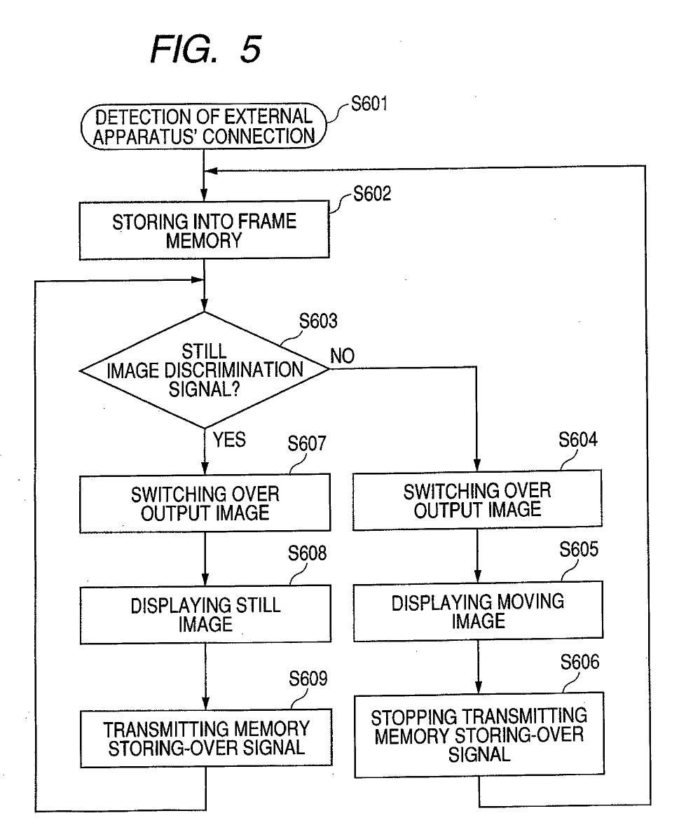

FIG. 5 is a flow chart describing the functions of the image control apparatus 105 of the present invention.

When a connection to the image output apparatus 101 is detected through a cable (S601), a transmitted image signal is stored in the frame memory 201 (S602).

Then a discrimination is executed (S603) as to whether the still image discrimination signal to be transmitted from the image output apparatus 101 is present.

In case of absence of the still image discrimination signal in S603, the switching-over unit 202 executes a switching-over of the output image (S604), thereby displaying a moving image (S605). Also in the case that the memory storing-over signal is transmitted, the output thereof is terminated (S606) and the sequence proceeds to S602.

On the other hand, in the case that the still image discrimination signal is present in S603, the switching-over unit 202 executes a switching-over of the output image (S607), thereby displaying a still image (S608). Also the memory storing-over signal is transmitted (S609), and the sequence proceeds to S603.

In the foregoing description, the memory storing-over signal transmitted from the image control apparatus 105 has been described as a signal executing a control by transmission/termination thereof, but such control may also be executed by a specified command. In such case, the control is executed in accordance with not the transmission/termination of a signal, but transmission of a storing-over command/transmission of an image signal re-request command. Same applies to the still image discrimination signal transmitted from the image output apparatus 101.

### Exemplary Embodiment 2

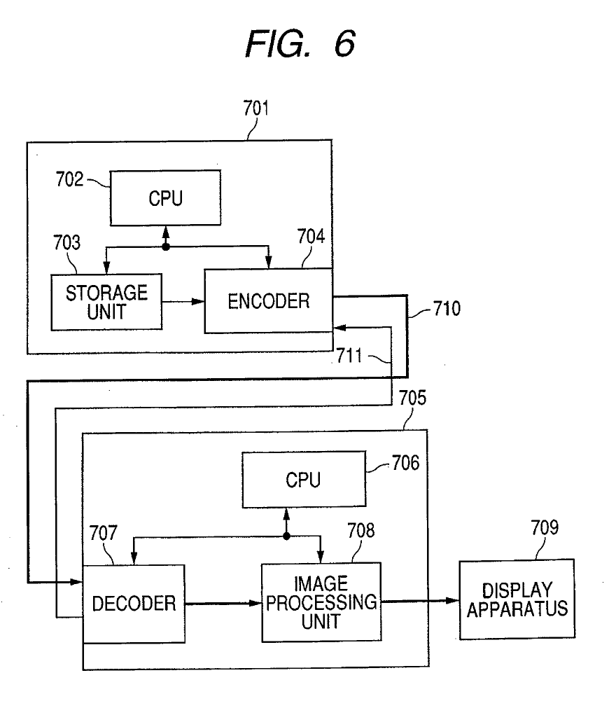

FIG. 6 is an entire block diagram illustrating an image display system utilizing an image control apparatus of a second exemplary embodiment of the present invention. It is different from the exemplary embodiment 1 in that an image output apparatus 701 outputs image data, stored in a storage unit 703, as a compressed data through an encoder 704, and that an image control apparatus 705 receives the image signal through a decoder 707.

Also the image output apparatus 701 does not output the still image discrimination signal, and the image control apparatus 705 discriminates whether the image signal represents a still image or a moving image.

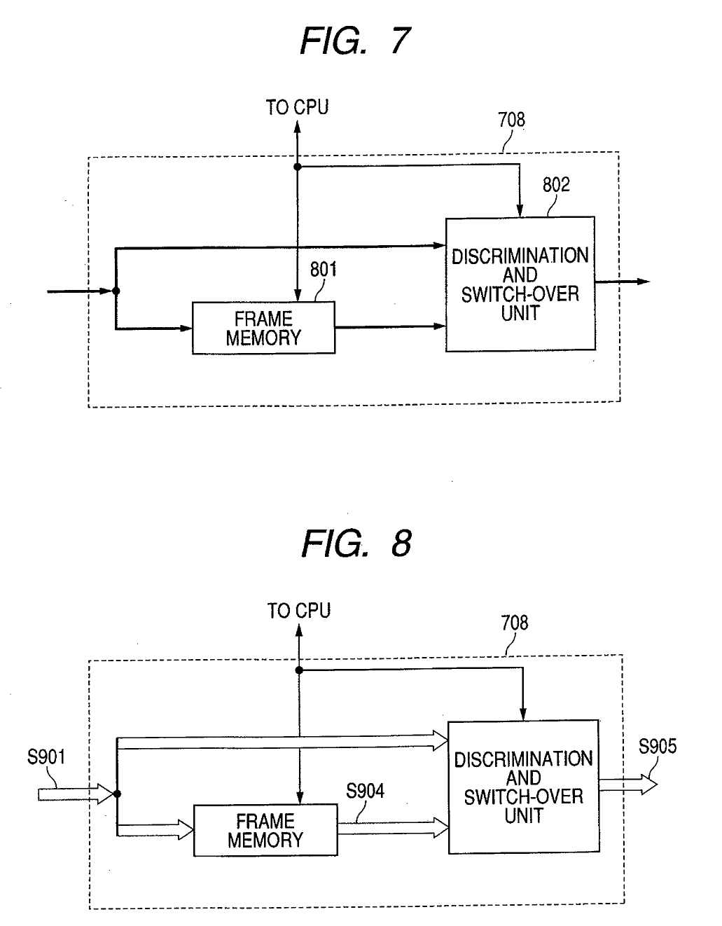

An image processing unit 708 includes, as illustrated in FIG. 7, a frame memory 801 capable of storing the image signal of at least a frame, and a discrimination and switching-over unit 802 which executes a discrimination by comparing the input image signal and the image signal read out from the frame memory 801 and outputs the image signal under a switch-over.

In the case that the image input to the image control apparatus 705 is a moving image, the discrimination and switching-over unit 802 discriminates the input image signal as a moving image, thus outputs the input image signal and informs the CPU 706 of such information. In this case, for the encoder 704 and the decoder 707, the image signal transmitted through the signal line 710 is an ordinary image signal not requiring a particular control, so that the signal line 711 is not used.

FIG. 8 is a view describing the signal flow in the image processing unit 708, when a moving image data is input to the image control apparatus 705.

The discrimination and switching-over unit 802 discriminates whether the input image is a moving image or a still image, by comparing an input image signal S901 with an image signal S904 preceding by at least one frame, read out from the frame memory 801, and switches over the output. In case of a discrimination as a moving image, the input image signal S901 is selected and is output as an output image signal S905, and, in case of a discrimination as a still image, the image signal S904 is selected and output as the output image signal S905. Discrimination of still image and moving image is executed for example by comparing average picture luminance level (APL) of the image data between different frames. More specifically, a moving image is discriminated when the difference in APL is equal to or larger than a predetermined threshold value.

Such threshold value may be made adjustable by the user.

Also a frame delay amount used for the comparison may be set by an instruction from the CPU 706 or may be made adjustable by the user.

It is also possible to improve the precision of detection of the still image, by providing plural units of the frame memory and thus increasing the number of frames of the image data to be compared.

The discrimination and switching-over unit 802, upon discriminating the input image as a still image, informs the CPU 706 of such result. The CPU 706 gives an instruction to the frame memory 801, thus terminating the writing into the frame memory 801.

Also the CPU 706 gives an instruction to the decoder 707, and informs, through the signal line 711, the image output apparatus 701 of a fact that the image control apparatus 705 is in the course of an output utilizing the frame memory 801.

In the image output apparatus 701, this information is transmitted through the encoder 704 to the CPU 702. The CPU 702, not being required to continue the output of the image signal, shifts to a power saving mode, and enters a state of waiting for a new input from the user.

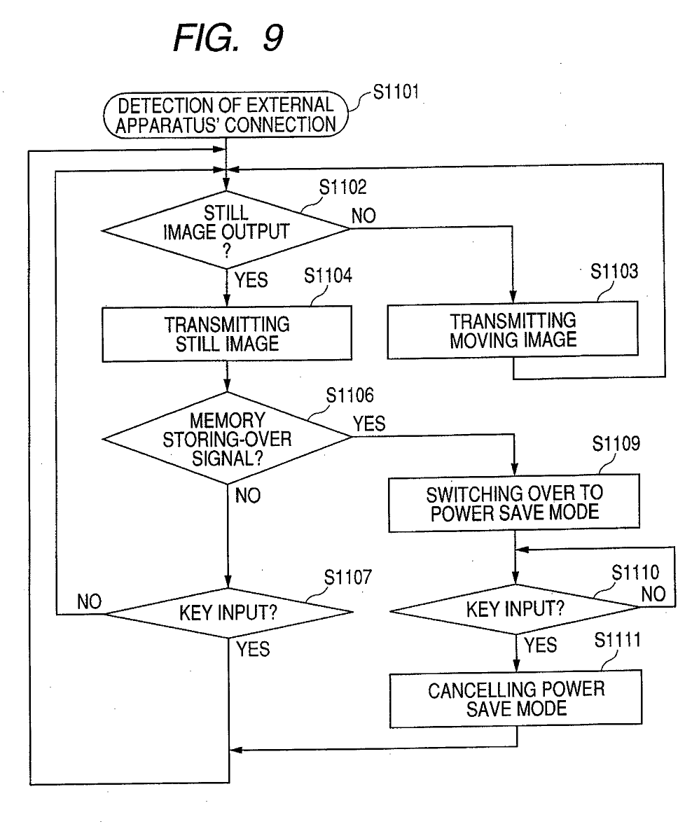

FIG. 9 is a flow chart describing the functions of the image output apparatus 701. Description will be omitted as it is same as in the exemplary embodiment 1 except that the still image discrimination signal is not transmitted.

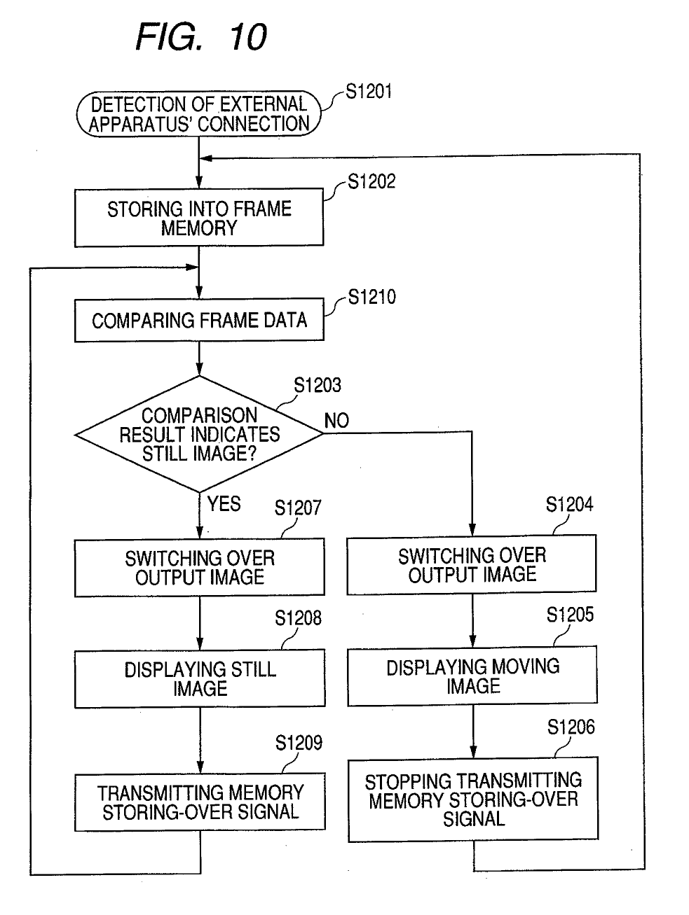

FIG. 10 is a flow chart describing the functions of the image control apparatus 705 in the present exemplary embodiment.

A discrimination and switching-over unit 802 executes a comparison of frame data (S1210), and, based on the result of the comparison, executes a discrimination (S1203) whether the image signal transmitted from the image output apparatus 701 is a still image or a moving image.

Other functions similar to those in the exemplary embodiment 1 will not be described further.

In the case that the image output apparatus 701 enters the power saving mode or the like and transmission of the image signal is terminated, the comparison of frame data in S1210 does not execute the detection by comparison. Thus, when the input image signal is no signal, namely a black image, discrimination is made as a still image and the image stored in the frame memory 701 is displayed.

In the foregoing, it has been described as an exemplary embodiment to shift to the power saving mode in case of a still image, but it is also possible to provide plural frame memories for storing a short moving image, and to enable a shift to the power saving mode also in case of a short moving image, as in the case of still image described above.

It is also possible, as another exemplary embodiment, to dispense with the switching-over unit 202 and, to output, from the receiver 107 to the image output apparatus 101, a control signal for controlling the output of the image signal in the case that the CPU 106 serving as the discrimination unit discriminates the input image signal as a still image. In such case, the CPU 106 controls a frame memory control unit (not shown) so as to inhibit writing into the frame memory 201. In response to the received control signal, the image output apparatus 101 shifts to a power saving mode in which the output of the image signal is terminated or the transfer rate of the image signal is lowered. In the case that the image output apparatus 101 terminates the output of the image signal, the image signal writing into the frame memory 201 is terminated, and the image signal stored therein is output to the display apparatus 109 and displayed as a still image. On the other hand, in the case that the CPU 106 discriminates the input image signal as a moving image, the control signal is not output and the image signal transmitted from the image output apparatus 101 is written in succession into the frame memory 201. The image signal is read from the frame memory 201 synchronously or asynchronously with the writing operation into the frame memory 201, and is output to the display apparatus 109 for a display as a moving image.

Incidentally, it is needless to say that the objects of the present invention are also achieved by supplying a storage medium, which records a program code of software that can implement the functions of the above-mentioned exemplary embodiments to a system or an apparatus, that is, by reading out and executing the program code stored in the storage medium by a computer (or a CPU or MPU) of the system or the apparatus. In this case, the program code itself read out from the storage medium implements the functions of the above-mentioned exemplary embodiments, and the storage medium which stores the program code constitutes the present invention.

As the storage medium for supplying the program code, for example, a flexible disk, a hard disk, an optical disk, a magneto-optical disk, a CD-ROM, a CD-R, a magnetic tape, a nonvolatile semiconductor memory card, a ROM, and the like may be used. Further, there is a possibility that the functions of the above-mentioned exemplary embodiments can be implemented when the computer executes the read program code.

Further, it is needless to say that the present invention includes a case where the functions of the above-mentioned exemplary embodiments are implemented by some or all of actual processing operations executed by an OS (operating system) running on the computer based on an instruction of the program code.

Furthermore, it is needless to say that the present invention also includes a case where the functions of the above-mentioned exemplary embodiments are implemented by some or all of actual processing operations executed by a CPU or the like arranged in a function extension board or a function extension unit, which inserted in or connected to the computer, after the program code read out from the storage medium is written in the memory of the extension board or unit.

While the present invention has been described with reference to the exemplary embodiments, it is to be understood that the invention is not limited to the disclosed exemplary embodiments. The scope of the following claims is to be accorded the broadcast interpretation so as to encompass all such modifications and equivalent structures and functions.

This application claims priority from Japanese Patent Application No. 2006-061226 filed on Mar. 7, 2006, which is hereby incorporated by reference herein.

1. An image control apparatus capable of being externally connected to an image output apparatus with an interface comprising a uni-directional data line and a bi-directional control line, comprising:
an input/output unit, which inputs an image signal output from the image output apparatus via the uni-directional data line;
a frame memory, which stores the input image signal;
a discrimination unit, which discriminates whether the input image signal is an image signal for displaying a still image or an image signal for displaying a moving image; and
a switching-over unit, which selectively outputs, based on an output of the discrimination unit, one of the input image signal and an image signal read out from the frame memory;
wherein the input/output unit outputs an information signal via the bi-directional control line which informs the image output apparatus of a fact that the switching-over unit is outputting an image signal read out from the frame memory.

2. An image control apparatus according to claim 1, wherein the image signal read out from the frame memory is an image signal preceding by at least a frame to the input image signal.

3. An image control apparatus according to claim 1, wherein the switching-over unit outputs the image signal read out from the frame memory in the case that the image signal is an image signal for displaying a still image, and outputs the input image signal in the case that the image signal is an image signal for displaying a moving image.

4. An image control apparatus according to claim 3, wherein the information signal is a signal for causing the image output apparatus to terminate the output of the image signal.

5. An image control apparatus according to claim 1, wherein the discrimination unit discriminates whether the input image signal is an image signal for displaying a still image or an image signal for displaying a moving image, based on an image discrimination signal output from the image output apparatus.

6. An image control apparatus according to claim 1, wherein the discrimination unit discriminates whether the input image signal is an image signal for displaying a still image or an image signal for displaying a moving image, based on a comparison of the image signal stored in the frame memory and the input image signal.

7. (canceled)

8. An image output apparatus capable of being externally connected to an image control apparatus with an interface comprising a uni-directional data line and a bi-directional control line, which comprises:
an input/output unit, which outputs an image signal to the image control apparatus via the uni-directional data line;
an image discrimination unit, which discriminates whether the image signal is an image signal for displaying a still image or an image signal for displaying a moving image, and outputs an image discrimination signal to the image control apparatus via the bi-directional control line; and
a control unit, which executes a control to terminate an output of the image signal to the image control apparatus when an information signal is received from the image control apparatus via the bi-directional control line.

9. An image control apparatus capable of being externally connected to an image output apparatus with an interface comprising a uni-directional data line and a bi-directional control line, comprising:
an input/output unit, which inputs an image signal output from the image output apparatus via the uni-directional data line;
a frame memory, which stores the input image signal; and
a control unit, which controls the frame memory so as to inhibit writing the input image signal when the input image signal is an image signal for displaying a still image based on an image discrimination signal which discriminates whether the image signal is an image signal for displaying a still image or an image signal for displaying a moving image, the image discrimination signal being output from the image output apparatus via the bi-directional control line.

10. A control method for an image control apparatus capable of being connected to an image output apparatus with an interface comprising a uni-directional data line and a bi-directional control line, the method comprises the steps of:
inputting an image signal output from the image output apparatus via the uni-directional data line;
storing the input image signal in a frame memory;
discriminating whether the input image signal is an image signal for displaying a still image or an image signal for displaying a moving image; and
controlling, based on the result of discrimination, output to the image output apparatus via the bi-directional control line, which is a signal for causing the image output apparatus to terminate the output of the image signal when the image signal is an image signal for displaying a still image.
